(19) United States
(12) Patent Application Publication
(10) Pub. No.: US 2026/0048443 A1
(43) Pub. Date: Feb. 19, 2026

(54) SAW ASSEMBLY

(71) Applicant: MILWAUKEE ELECTRIC TOOL CORPORATION, Brookfield, WI (US)

(72) Inventor: Helton F. Vandenbush, Belgium, WI (US)

(21) Appl. No.: 19/301,179

(22) Filed: Aug. 15, 2025

Related U.S. Application Data
(60) Provisional application No. 63/683,805, filed on Aug. 16, 2024.

(51) Int. Cl. B23D 45/00; B23D 45/16

(52) U.S. Cl. CPC B23D 45/006; B23D 45/003; B23D 45/16

(57) ABSTRACT

A rail adapter may include a mount configured to couple to the workpiece. A rail adapter may include a first arm having a first end pivotably coupled to the mount about a first pivot axis and an opposite second end. A rail adapter may include a second arm having a first end pivotably coupled to the first arm about a second pivot axis and an opposite second end. A rail adapter may include a mounting bracket pivotably coupled to the second end of the second arm and mounted to the saw. A rail adapter may include a first pivot lock engageable to inhibit a first degree of freedom of the mounting bracket and the saw. A rail adapter may include a second pivot lock engageable to inhibit a second degree of freedom of the mounting bracket and the saw, the second degree of freedom being different from the first.

### CROSS-REFERENCE TO RELATED APPLICATIONS

This application claims priority to U.S. Provisional Patent Application No. 63/683,805, filed Aug. 16, 2024, the entire contents of which are incorporated herein by reference.

### FIELD OF THE INVENTION

The present invention relates to a saw assembly, and more particularly to a saw assembly including a saw and a rail adapter.

### BACKGROUND OF THE INVENTION

Saws, such as rail saws or cut-off saws, are sometimes used in the cutting of railroad sections. In such operations, the saw is coupled to an adapter to align the saw to cut a piece of railroad section. For example, the adapter is first clamped and secured to the piece of railroad section. Then, the saw is coupled to the adapter so that the saw blade can make a straight cut perpendicular to the length of the railroad section.

### SUMMARY

In some aspects, the techniques described herein relate to a rail adapter for supporting a saw on a workpiece, the rail adapter including: a mount configured to couple to the workpiece; a first arm having a first end pivotably coupled to the mount about a first pivot axis and an opposite second end; a second arm having a first end pivotably coupled to the first arm about a second pivot axis and an opposite second end; a mounting bracket pivotably coupled to the second end of the second arm and mounted to the saw; a first pivot lock engageable to inhibit a first degree of freedom of the mounting bracket and the saw; and a second pivot lock engageable to inhibit a second degree of freedom of the mounting bracket and the saw, the second degree of freedom being different from the first.

In some aspects, the techniques described herein relate to a system for cutting through railroad sections, the system including: a saw including, a housing, a support arm extending from the housing, a cutting wheel supported at one end of the support arm, and a blade guard covering a portion of the cutting wheel; a rail adapter including, a mount configured to couple to a railroad section; a first arm having a first end pivotably coupled to the mount and an opposite second end; a second arm having a first end pivotably coupled to the first arm and an opposite second end; a mounting bracket pivotably coupled to the second end of the second arm and mounted to the saw; and a control device having a first end coupled to the first arm and a second end coupled to the second arm, the control device biasing the first arm away from the second arm to partially support the weight of the saw above the railroad section.

In some aspects, the techniques described herein relate to a system for cutting through railroad sections, the system including: a saw including, a housing, a support arm extending from the housing, a cutting wheel supported at one end of the support arm, and a blade guard covering a portion of the cutting wheel; a rail adapter including: a mount configured to couple to a railroad section, a first arm having a first end pivotably coupled to the mount and an opposite second end, and a second arm having a first end pivotably coupled to the first arm and an opposite second end, a mounting bracket pivotably coupled to the second end of the second arm and mounted to the saw; and a spark plate positioned behind the cutting wheel and under the blade guard to prevent sparks from contacting a user.

Other aspects of the invention will become apparent by consideration of the detailed description and accompanying drawings.

### BRIEF DESCRIPTION OF THE DRAWINGS

FIG. 1 is a first perspective view of a saw assembly in accordance with an embodiment of the invention.

FIG. 2 is a second perspective view of the saw assembly of FIG. 1.

FIG. 3 is a top view of a portion of the saw assembly of FIG. 1.

FIG. 4 is a perspective view of a saw assembly according to another embodiment of the invention.

FIGS. 5A-5C illustrate a method of cutting a railroad section.

FIG. 6 is a top view of a saw assembly according to another embodiment of the invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

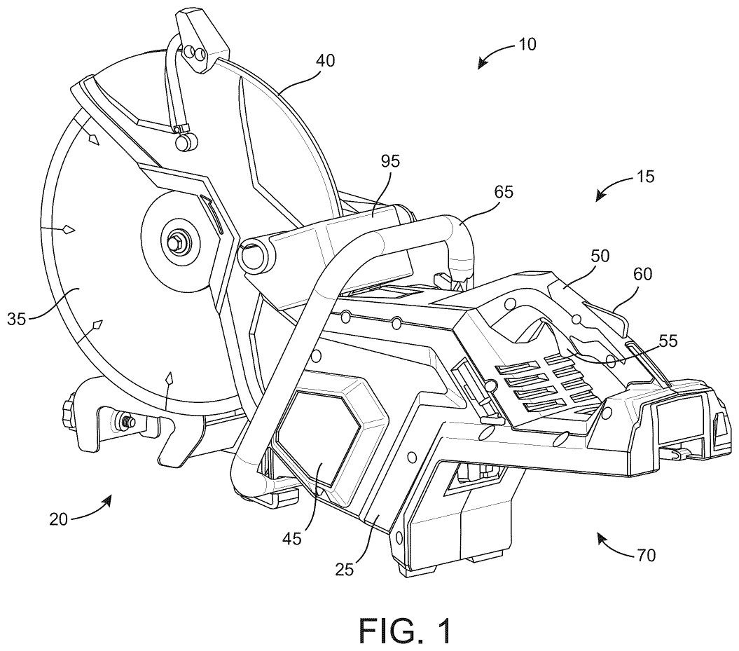

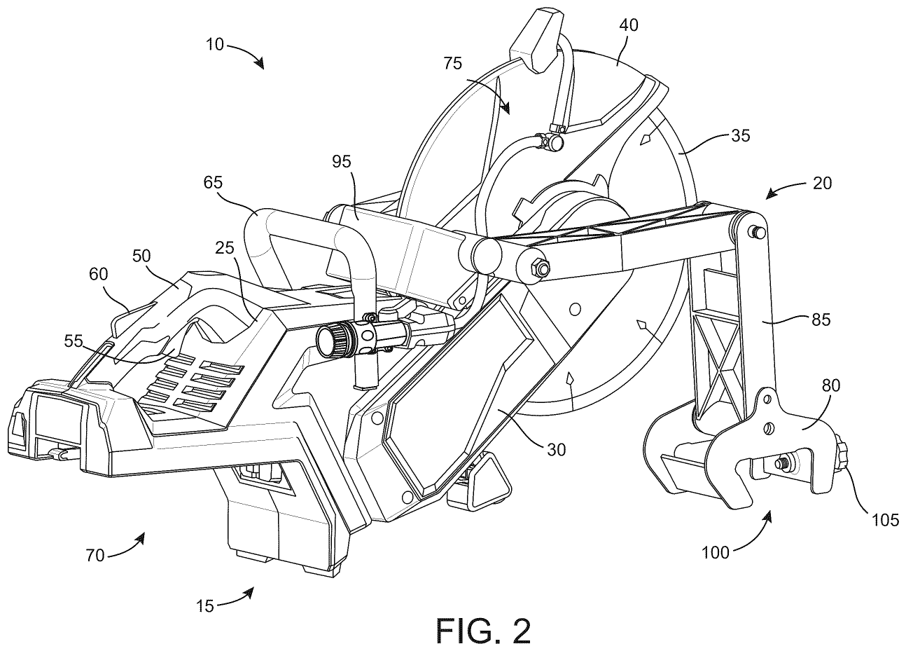

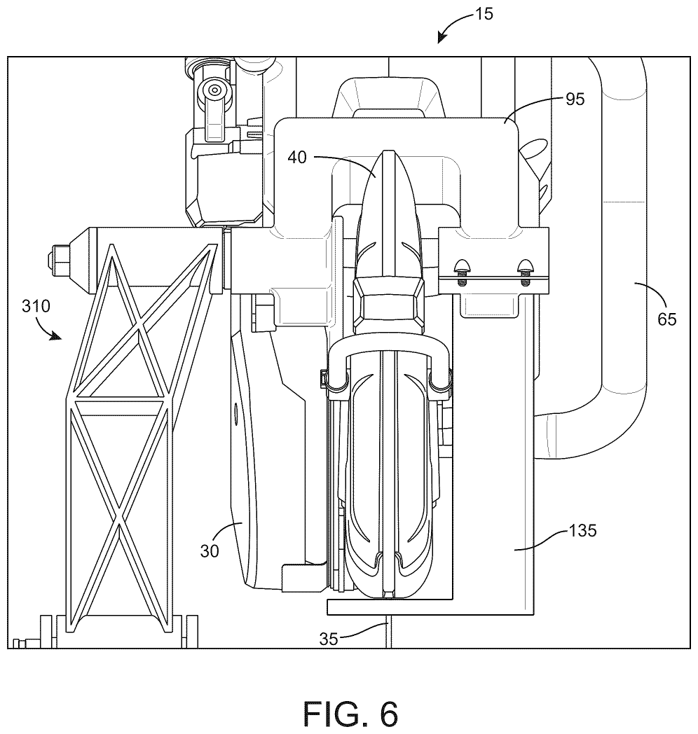

FIGS. 1 and 2 illustrate a saw assembly 10 including a saw 15 and a mount or rail adapter 20. The saw assembly 10 is attachable to a workpiece to make a straight cut on the workpiece (e.g., a piece of railroad section 22; FIG. 5A). In the illustrated embodiment, the saw 15 is a cut-off saw that may be used for cutting hard materials such as concrete, steel, or the like. The saw 15 includes a housing 25, a support arm 30 coupled to and extending from the housing 25, a cutting wheel 35 carried by the support arm 30, and a guard 40 covering a portion of the circumference of the cutting wheel 35. The cutting wheel 35 can be a blade, an abrasive disk, or any other rotatable element capable of removing material from a workpiece. A motor housing portion 45 of the housing 25 supports an electric motor (e.g., a brushless direct current electric motor) operable to transfer torque to the cutting wheel 35 through a transmission positioned within the support arm 30.

The saw 15 also includes a rear handle 50 that extends from the rear of the housing 25 in a direction generally opposite the support arm 30. A trigger 55 for operating the saw 15 and a lockout trigger 60 that prevents the user from pulling the trigger 55 unless it is first depressed are both located on the rear handle 50. The saw 15 also includes a front handle 65 that wraps around an upper portion of the housing 25 and that in conjunction with the rear handle 50, provides gripping regions to facilitate two-handed operation of the saw 15. The saw 15 further includes a battery receptacle 70, which is positioned beneath the rear handle 50 and operable to receive a removable battery pack. The saw 15 may also include a fluid distribution system 75 (FIG. 2) that is operable to discharge fluid onto each side of the cutting wheel 35 for cooling, lubrication, and dust abatement.

With continued reference to FIG. 2, the rail adapter 20 includes a clamp 80, a first arm 85, a second arm 90, and a mounting bracket 95. The clamp 80 includes a mouth 100 that is sized and shaped to receive a portion of a workpiece (i.e., railroad section 22; FIG. 5A). The clamp 80 supports a fastener 105 (e.g., a setscrew or threaded rod) that is rotatable to secure the rail adapter 20 to the workpiece. The first arm 85 is pivotably coupled to the clamp 80 at a first end about a first pivot axis and pivotably coupled to the second arm 90 at a second end opposite the first about a second pivot axis. The second arm 90 is pivotably coupled to the first arm 85 at a first end and pivotably coupled to the mounting bracket 95 at a second end opposite the first end about a third pivot axis. As such, the first and second arms 85, 90 may articulate to a plurality of positions within a cutting plane.

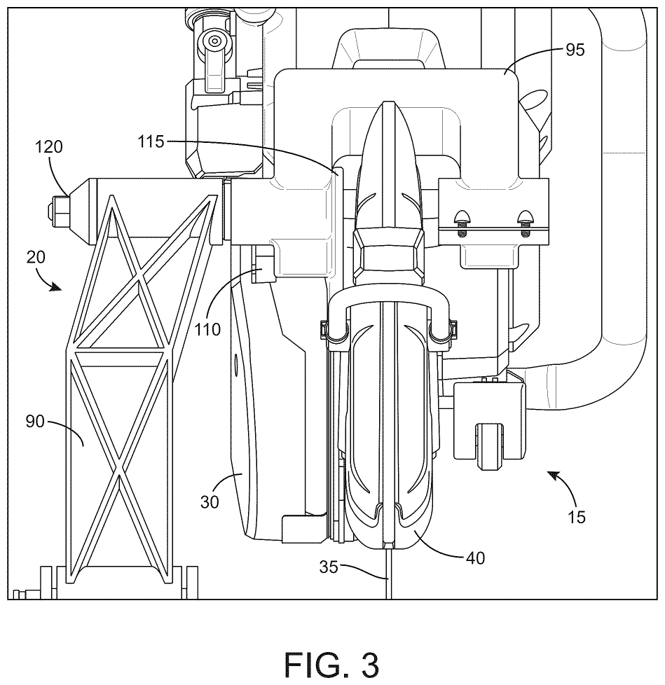

Referring to FIG. 3, the mounting bracket 95 is generally C-shaped and extends over the guard 40 and cutting wheel 35. The mounting bracket 95 is coupled to the support arm 30 through first and second brackets 110, 115. The first bracket 110 extends from the interior of the support arm 30 and the second bracket 115 is coupled to an outside surface of the support arm 30 closest to the cutting wheel 35. The first and second brackets 110, 115 may be coupled to the support arm 30 using fasteners such as screws, nails, bolts, or the like. In some embodiments, the mounting bracket 95 may be coupled to the guard 40.

In the illustrated embodiment, the rail adapter 20 is separate from the saw 15. In other words, the rail adapter 20 may be sold as an aftermarket accessory to mount the saw 15 onto a workpiece. As shown in FIG. 3, the mounting bracket 95 may be fixed to the support arm 30 and the rail adapter 20 may be removably coupled to the mounting bracket 95. For example, the second end of the second arm 90 may include a fastener 120 that, when threaded to the bracket 110, secures the rail adapter 20 to the mounting bracket 95. In some embodiments, the mounting bracket 95 along with the other components of the rail adapter 20 may be selectively coupled to the support arm 30. In other embodiments, the saw 15 and the rail adapter 20 may be integrated as a single unit. In other words, the rail adapter 20 and the saw 15 may be permanently attached, such that the rail adapter 20 is non-removable from the saw 15.

To perform a cutting operation, the rail adapter 20 can first be coupled to the workpiece 22 by placing the mouth 100 over the workpiece 22 and tightening the fastener 105. A user may then couple the saw 15 to the rail adapter 20, either by using the fastener 120 to couple the second arm 90 to the support arm 30 or by coupling the mounting bracket 95 to the support arm 30 or guard 40. The saw assembly 10 can then be used to make straight and precise cuts in the workpiece 22 in a direction perpendicular to the length of the workpiece.

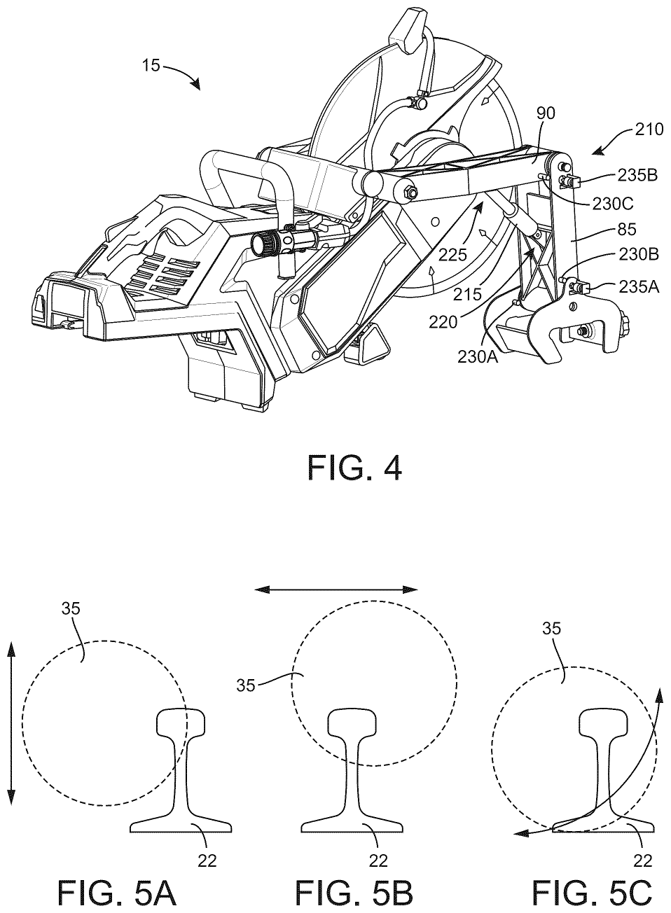

FIG. 4 illustrates a rail adapter 210 for use with the cut-off saw 15 according to another embodiment. The rail adapter 210 is similar to the rail adapter 20 discussed above, with like features being represented with like reference numbers. The rail adapter 210 includes a control device 215 positioned between the first and second arms 85, 90. Specifically, the control device 215 includes a first end 220 coupled to the first arm 85 and a second end 225 coupled to the second arm 90. The control device 215 applies a biasing force between the first and second arms 85, 90 to assist in keeping the cut-off saw 15 supported above a rail 22 during a cutting operation. In other words, the control device 215 forces the first and second arms 85, 90 away from each other to alleviate some of the force and weight required by the user to move the cut-off saw 15 during a cutting operation. For example, the control device 215 may include a spring or a piston cylinder. The control device 215 allows a user to focus on the alignment of the cut rather than the weight of the saw 15.

With continued reference to FIG. 4, the rail adapter 210 also includes a plurality of stops 230 located adjacent the pivot axes of the rail adapter 210 to prevent the over travel of the first or second arms 85, 90. A first stop 230A may be disposed on the clamp 80 to prevent the first arm 85 from pivoting too far. Similarly, a second stop 230B may be disposed on the first arm 85 to prevent the second arm 90 from pivoting too far. A third stop 230C may be disposed on the second arm 90 to prevent the second arm 90 from pivoting too far relative to the bracket 95. For example, the stops 230 may prevent users from accidentally cutting into the ground if the rail 22 is supported on the ground during a cutting operation. In other embodiments, the rail adapter 210 may include indicia adjacent the pivot axes to indicate the potential cutting depth of the cutting wheel 35.

As shown in FIGS. 5A-5C, rails 22 typically have a bigger overall size than a radius of the cutting wheel 35 (e.g., the half of the wheel that can make a cut). As such, users generally have to begin with cutting the rail 22 in a first direction (e.g., up and down), as shown in FIG. 5A, followed by a second direction (e.g., forward and backward), as shown in FIG. 5B, and then have to combine the two directions in a fluid arc-shaped cut to fully cut through the rail 22, as shown in FIG. 5C. With reference back to FIG. 4, in order to isolate between these movements, the rail adapter 210 includes pivot locks 235 that restrain one degree of freedom of movement. The pivot locks 235 are moveable by a user to lock out one of the degrees of freedom of the rail adapter 210 and thus the saw 15 and mounting bracket 95. For example, when needing to cut the rail 22 in the first direction, a first pivot lock 235A can be engaged, preventing the saw 15 from moving in a first degree of freedom and allowing a user to move the saw 15 along the first direction. The first pivot lock 235A is supported by the mount generally prevents the first arm 85 from pivoting relative to the mount 80. Similarly, when needing to cut the rail 22 in the second direction, a second pivot lock 235B can be engaged, preventing the saw 15 from moving in a second degree of freedom that is different from the first degree of freedom and allowing a user to move the saw 15 along the second direction. The second pivot lock 235B is supported by the first arm 85 and prevents the second arm 90 from pivoting relative to the first arm 85. The first and second pivot locks 235A, 2335B are generally prevented from being engaged at the same time so the rail adapter 210 is not locked out. However, in some embodiments, the first and second pivot locks 235A, 235B may be engageable at the same time to assist a user while transporting the rail adapter 210 and/or saw 15. In some embodiments, the first and second pivot locks 235A, 235B are slidable to inhibit the first or second degrees of freedom.

FIG. 6 illustrates a rail adapter 310 according to another embodiment of the invention. The rail adapter 310 is similar to the rail adapter 20 with like features being represented with like reference numbers. The rail adapter 310 includes a spark plate 315 that extends down from the mounting bracket 95. The spark plate 315 extends behind the cutting wheel 35 and blade guard 40 to prevent sparks produced during a cutting operation from contacting a user. In other words, the spark plate 315 is positioned in front of the rear and front handles 50, 65 to prevent sparks from contacting a user's legs. In the illustrated embodiment, the spark plate 315 extends along an opposite side of the cutting wheel 35 than the rail adapter 310. In other embodiments, the spark plate 315 may extend along the same side of the cutting wheel 35 as the rail adapter 310. In some embodiments, the spark plate 315 may include a spark collector bin to store and contain metal chips that are produced during a cutting operation. In other embodiments, the spark plate 315 may be coupled to either side of the rail adapter 20. In further embodiments, the rail adapter 20 may include a spark plate 315 extending from each side of the bracket 95 and behind the wheel 35.

Although the invention has been described in detail with reference to certain preferred embodiments, variations and modifications exist within the scope and spirit of one or more independent aspects of the invention as described.

Various features of the disclosure are set forth in the following claims.

What is claimed is:

1. A rail adapter for supporting a saw on a workpiece, the rail adapter comprising:
a mount configured to couple to the workpiece;
a first arm having a first end pivotably coupled to the mount about a first pivot axis and an opposite second end;
a second arm having a first end pivotably coupled to the first arm about a second pivot axis and an opposite second end;
a mounting bracket pivotably coupled to the second end of the second arm and mounted to the saw;
a first pivot lock engageable to inhibit a first degree of freedom of the mounting bracket and the saw; and
a second pivot lock engageable to inhibit a second degree of freedom of the mounting bracket and the saw, the second degree of freedom being different from the first degree of freedom.

2. The rail adapter of claim 1, wherein the first pivot lock prevents the first arm from pivoting relative to the mount.

3. The rail adapter of claim 2, wherein the second pivot lock prevents the second arm from pivoting relative to the first arm.

4. The rail adapter of claim 1, wherein the first pivot lock is supported by the mount.

5. The rail adapter of claim 4, wherein the second pivot lock is supported by the first arm.

6. The rail adapter of claim 1, further comprising indicia adjacent the second pivot axis indicating a cutting depth of the saw.

7. The rail adapter of claim 1, further comprising indicia adjacent the first pivot axis indicating a cutting depth of the saw.

8. The rail adapter of claim 1, wherein the first and second pivot locks are prevented from being engaged at the same time.

9. The rail adapter of claim 1, wherein the first and second pivot locks are slidable to inhibit the first or second degrees of freedom.

10. A system for cutting through railroad sections, the system comprising:
a saw including
a housing,
a support arm extending from the housing,
a cutting wheel supported at one end of the support arm, and
a blade guard covering a portion of the cutting wheel; and
a rail adapter including
a mount configured to couple to a railroad section,
a first arm having a first end pivotably coupled to the mount and an opposite second end,
a second arm having a first end pivotably coupled to the first arm and an opposite second end,
a mounting bracket pivotably coupled to the second end of the second arm and mounted to the saw, and
a control device having a first end coupled to the first arm and a second end coupled to the second arm, the control device biasing the first arm away from the second arm to partially support the weight of the saw above the railroad section.

11. The system of claim 10, wherein the control device includes a spring or a piston cylinder.

12. The system of claim 10, wherein the first end of the control device is coupled between the first and second ends of the first arm, and wherein the second end of the control device is coupled between the first and second ends of the second arm.

13. The system of claim 10, wherein the mounting bracket is c-shaped and extends over the cutting wheel of the saw.

14. The system of claim 10, wherein the second arm is removably coupled to the mounting bracket with a fastener.

15. The system of claim 10, wherein the rail adapter includes a stop adjacent the first or second arms to prevent the cutting wheel from contacting the ground during a cutting operation.

16. A system for cutting through railroad sections, the system comprising:
a saw including
a housing,
a support arm extending from the housing,
a cutting wheel supported at one end of the support arm, and
a blade guard covering a portion of the cutting wheel; and
a rail adapter including
a mount configured to couple to a railroad section,
a first arm having a first end pivotably coupled to the mount and an opposite second end,
a second arm having a first end pivotably coupled to the first arm and an opposite second end,
a mounting bracket pivotably coupled to the second end of the second arm and mounted to the saw, and
a spark plate positioned behind the cutting wheel and under the blade guard to prevent sparks from contacting a user.

17. The system of claim 16, wherein the spark plate extends from the mounting bracket.

18. The system of claim 16, wherein the saw further includes a rear handle extending from the housing in an opposite direction from the support arm and a front handle, and wherein the spark plate is positioned in front of the front and rear handles.

19. The system of claim 16, wherein the spark plate extends along an opposite side of the cutting wheel from the rail adapter.

20. The system of claim 16, wherein the spark plate extends from the blade guard.
